(19) United States
(12) Patent Application Publication
(10) Pub. No.: US 2022/0167595 A1
(43) Pub. Date: Jun. 2, 2022

(54) Adjustable Heat Lamp Support System for Brooders

(71) Applicants: Victor Justin Brewer, Centerberg, OH (US); Larry Lee Brewer, Millersport, OH (US); Daniel Kearney Swick, Johnstown, OH (US)

(72) Inventor: Victor Justin Brewer, Centerberg, OH (US)

(73) Assignees: Larry Lee Brewer, Millersport, OH (US); Daniel Kearney Swick, Johnstown, OH (US)

(21) Appl. No.: 17/541,024

(22) Filed: Dec. 2, 2021

Related U.S. Application Data
(60) Provisional application No. 63/120,548, filed on Dec. 2, 2020.

(51) Int. Cl. A01K 41/02; F16M 11/16

(52) U.S. Cl. CPC A01K 41/02; F16M 11/16

(57) ABSTRACT

A brooder system includes a stock tank having opposed sides, a pair of attachment members each having a first portion secured to one of to the opposed sides of the stock tank and a second portion having a vertically-extending passage, a cross member having first and second end portions downwardly extending into the vertically-extending passages of the attachment members so that the cross member extends over the stock tank, and a heat lamp secured to the cross member over the stock tank. The cross member can be slidable within the vertically-extending passages to adjust a height of the heat lamp over the stock tank. The cross member can be flexible and elongate to bend to form an arch over the stock tank.

### CROSS-REFERENCE TO RELATED APPLICATIONS

This application claims the priority benefit of U.S. Provisional Patent Application No. 63/120,548 filed on Dec. 2, 2020, the disclosure of which expressly incorporated herein in its entirety by reference.

### STATEMENT REGARDING FEDERALLY SPONSORED RESEARCH

Not applicable

### PARTIES TO A JOINT RESEARCH AGREEMENT

Not Applicable

### REFERENCE TO APPENDIX

Not applicable

### FIELD OF THE INVENTION

The field of the present invention relates to heat lamp supports and, more particularly, to heat lamp supports for use with brooders.

### BACKGROUND OF THE INVENTION

Initially, newly hatched chickens or chicks, and other types of fowl and livestock, need a warm and secure place for the first four to six weeks of their lives. A heated enclosure used for raising baby poultry is often called a “brooder.” The brooder often includes a galvanized stock tank, or anything similar, that can keep the chicks enclosed in a safe area, and can withstand heat from a heat lamp. A cover made of cloth, a window screen, or the like can be placed over the open top of the stock tank to help keep the chicks contained inside the stock tank but still allow air circulation within the stock tank. The brooder should be large enough to allow the chicks to move around to find warmth when they want it, but also allow them to move into an area where it is cooler when they need it.

Chicks raised without their mother need a source of warmth because they cannot regulate their own heat. A common way to provide heat to the chicks is to place a radiant heat lamp above the stock tank. For example, a radiant heat lamp with a 250-watt infrared bulb or the like. Commercial radiant heat lamps typically have both a hanger and a squeeze clamp for either hanging or clamping the heat lamp into a desired position. It is important to securely hang or clamp the heat lamp because the heat lamp can start a fire if knocked over into contact with combustible material. Unfortunately, fires due to improperly secured brooder heat lamps are far too common.

The heat lamp must be secured out of reach of the baby chicks but close enough to the baby chicks to keep them warm. A thermometer at the bottom of the brooder is typically used to check the temperature at chick level. Initially, the height of the heat lamp must be adjusted to obtain and maintain a temperature of about 90-95° F. at the bottom of the brooder. Unfortunately, there is not a convenient and inexpensive method for adjusting the height of heat lamps above a broader in a secure manner. This needed repositioning of the heat lamp increases the risk of fire.

As chicks grow, they need less external heat. After the first week, the heat lamp must be gradually moved further away from the brooder in order to decrease the temperature at the bottom of the brooder. Typically, the temperature is reduced about 5° F. per week. This continued repositioning of the heat lamp further increases the risk of fire.

Accordingly, there exists a need for adjustable heat lamp systems and methods that adequately secure the heat lamp in a convenient and cost effective manner.

### SUMMARY OF THE INVENTION

The present invention provides adequate systems and methods which address at least one of the above-noted problems of the prior art. Disclosed herein is a support system for supporting a heat lamp over a brooder having opposed sides. The support system comprises, in combination, first and second attachment members each having a first portion adapted to be secured to the opposed sides of the brooder and a second portions having a vertically-extending passage, and a cross member having first and second end portions downwardly extending into the vertically-extending passages of the first and second attachment members. so that the cross member extends between the first and second attachment members.

Also disclosed a heat lamp system for a brooder having opposed sides. The heat lamp system comprises, in combination, first and second attachment members having a first portion adapted to be secured to the opposed sides of the brooder and a second portion having a vertically-extending passage, a cross member having first and second end portions downwardly extending into the vertically-extending passages of the first and second attachment members so that the cross member extends between the first and second attachment members, and a heat lamp secured to the cross member between the first and second attachment members.

Further disclosed is a brooder system comprising, in combination, a stock tank having opposed sides, first and second attachment members each having a first portion secured to one of to the opposed sides of the stock tank and a second portion having a vertically-extending passage, a cross member having first and second end portions downwardly extending into the vertically-extending passages of the first and second attachment members so that the cross member extends between the first and second attachment members over the stock tank, and a heat lamp secured to the cross member over the stock tank.

Even further disclosed is a heating method for a brooder having opposed sides. The heating method comprises the steps of, in combination, securing first and second attachment members to the opposed sides of the brooder, wherein the first and second attachment members have a first portion adapted to be secured to the opposed sides of the brooder and a second portion having a vertically-extending passage, extending first and second end portions of a cross member into the vertically-extending passages of the first and second attachment members, and securing a heat lamp to the cross member between the first and second attachment members.

From the foregoing disclosure and the following more detailed description of various preferred embodiments it will be apparent to those skilled in the art that the present invention provides a significant advance in the technology and art of heat lamp systems and methods. Particularly, significant in this regard is the potential the invention affords for providing reliable, inexpensive, convenient and effective systems and methods for securing and/or adjusting the position of a radiant heat lamp over a brooder. Additional features and advantages of the invention will be better understood in view of the detailed description provided below.

### BRIEF DESCRIPTION OF THE DRAWINGS

These and further objects of the invention will become apparent from the following detailed description.

FIG. 1 is a perspective view of an adjustable heat lamp support system secured to a stock tank brooder according to the present invention.

FIG. 2 is an enlarged, fragmented perspective view of an attachment member of the adjustable heat lamp support system of FIG. 1.

FIG. 3 is an outer side perspective view of the attachment member of the adjustable heat lamp support system of FIGS. 1 and 2.

FIG. 4 is an inner side perspective view of the attachment member of FIG. 3.

FIG. 5 is a flexible and elongate cross member of the adjustable heat lamp support system of FIGS. 1 and 2.

FIG. 6 is a first alternative cross member for use with the adjustable heat lamp support system of FIGS. 1 and 2.

FIG. 7 is a second alternative cross member for use with the adjustable heat lamp support system of FIGS. 1 and 2.

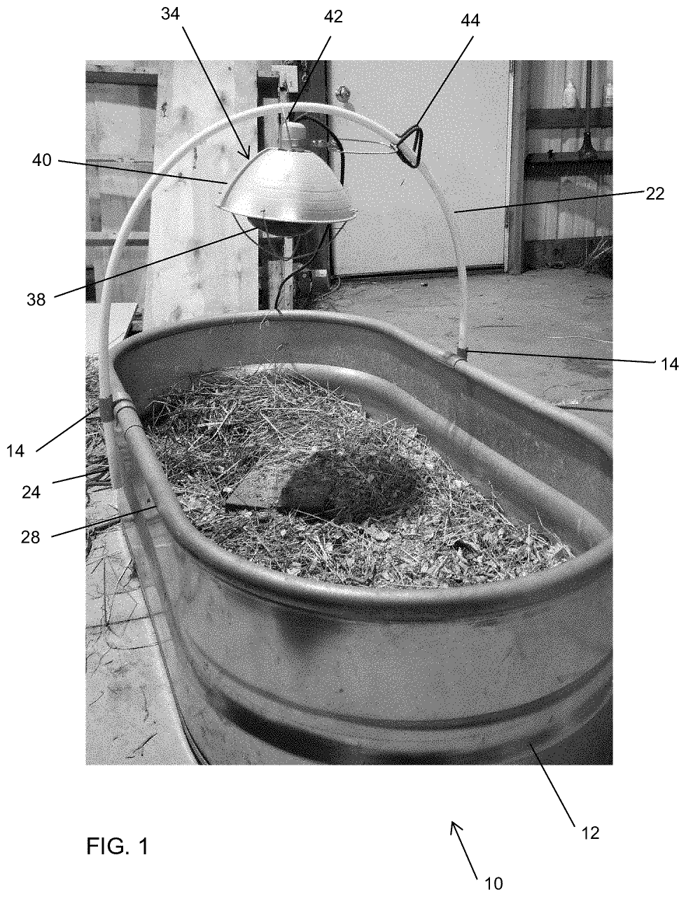

It should be understood that the appended drawings are not necessarily to scale, presenting a somewhat simplified representation of various preferred features illustrative of the basic principles of the invention. The specific design features of the various adjustable heat lamp systems as disclosed herein, including, for example, specific dimensions, orientations, locations, and shapes will be determined in part by the particular intended application and use environment. Certain features of the illustrated embodiments may have been enlarged or distorted relative to others to facilitate visualization and clear understanding. In particular, thin features may be thickened, for example, for clarity or illustration. All references to direction and position, unless otherwise indicated, refer to the orientation of the structures illustrated in the drawings. In general, up or upward generally refers to an upward direction within the plane of the page in FIG. 1 and down or downward generally refers to a downward direction within the plane of the page in FIG. 1. Also in general, fore or forward generally refers to a direction out the plane of the page in FIG. 1 and aft or rearward generally refers to an direction into the plane of the page in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the systems, devices, methods disclosed herein. The following detailed discussion of various alternative and preferred embodiments will illustrate the general principles of the invention with regard to the specific application of adjustably supporting a heat lamp over a stock tank brooder. Other embodiments suitable for other applications will be apparent to those skilled in the art given the benefit of this disclosure such as, for example but not limited to, other types of brooders, and heat lamp applications other than brooders.

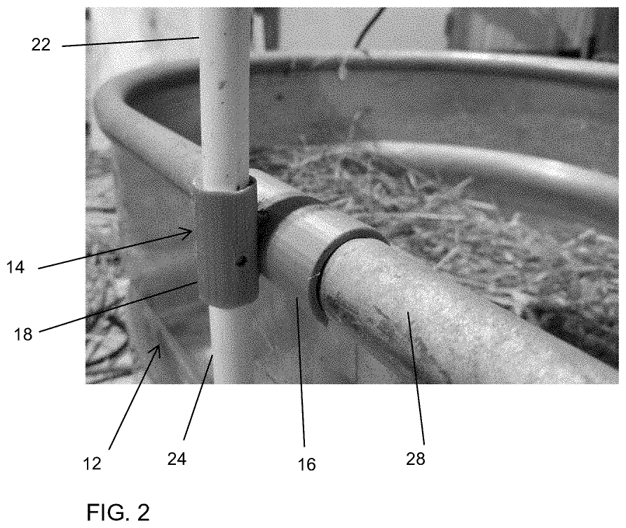

FIGS. 1 and 2 illustrate a heat lamp support system 10 for a brooder 12 according to the present invention. The illustrated heat lamp support system 10 includes a pair of attachment members 14 each having a first portion 16 adapted to be secured to the opposed sides of the brooder 12 and a second portion 18 having a vertically-extending passage 20, and a cross member 22 having first and second end portions 24, 26 downwardly extending into the vertically-extending passages 20 of the attachment members 14 so that the cross member 22 extends between the attachment members 14 and over the brooder 12.

The illustrated brooder 12 is a stock tank having a bottom wall, a side wall extending upward from and encircling the outer perimeter of the bottom wall to from an interior cavity. A top rim or edge 28 encircles the top of the side wall. The illustrated stock tank is generally oval shaped having a continuous front, rear, and opposed sides. It is noted that the stock tank can alternatively have any other suitable size, shape or configuration. The illustrated top rim or edge 28 is circular-shaped in cross section but can alternatively have any other suitable shape. The illustrated stock tank is made of galvanized steel but it is noted that any other suitable material can be utilized. A suitable stock tank is available from Rural King Supply having a headquarters at Mattoon, Ill. It is noted that the brooder 12 can have alternatively have any other suitable shape and/configuration and can be made from any other suitable material.

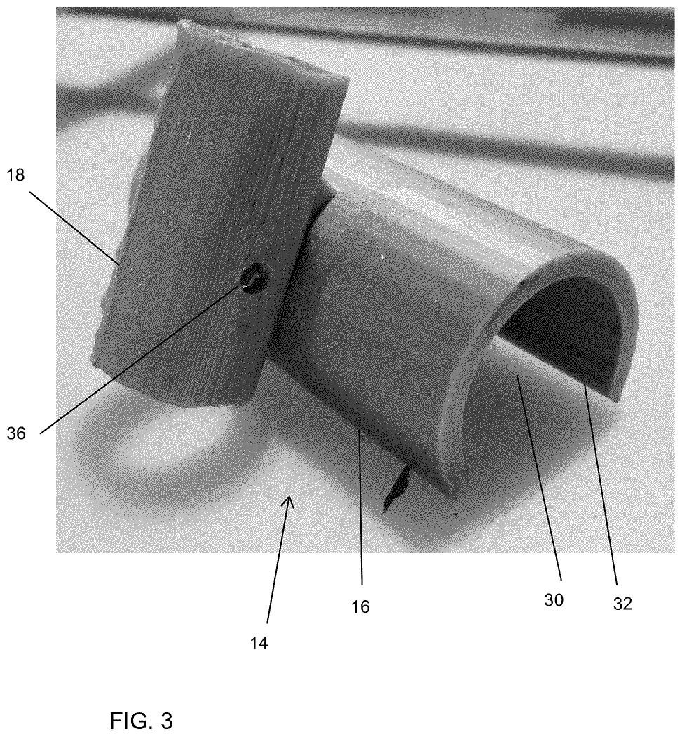

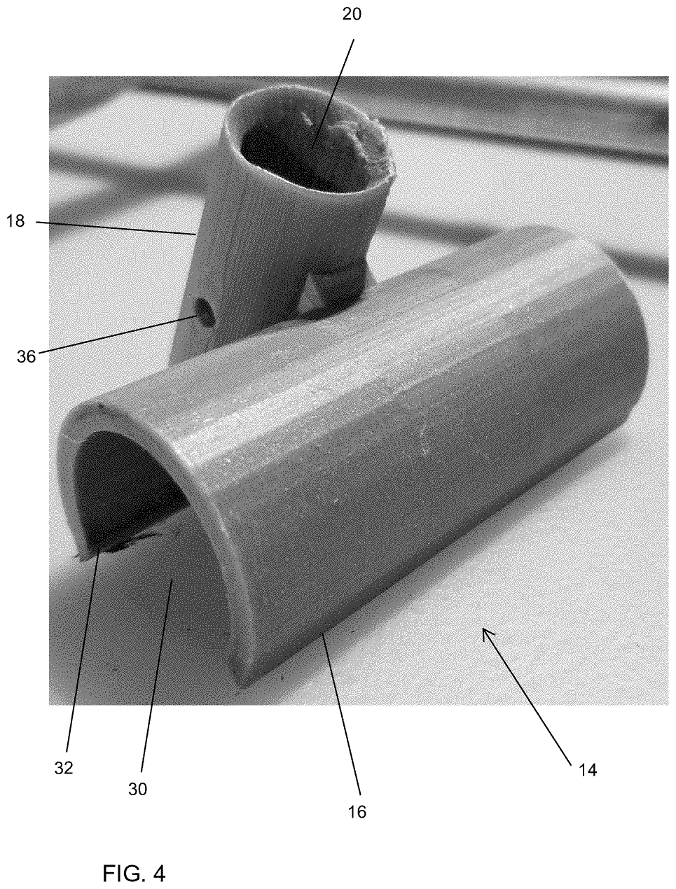

The illustrated attachment members 14 are identical with each having a first portion 16 adapted to be secured to the opposed sides of the brooder 12 at the upper edge or lip 28 and a second portion 18 having a vertically-extending passage 20 for receiving an end portion 24, 26 of the cross member 22. As best shown in FIGS. 3 and 4, the illustrated first portion 16 is configured as a downward facing C-section clamp. The C-section clamp forms a horizontally-extending passage 30 for receiving the upper rim or edge 28 of the brooder 12. The horizontally-extending passage 30 is open at both the front and rear ends of the first portion 16 so that the upper rim or edge 28 of the brooder 12 can extend therethrough and has a lower opening or slit 32 extending between the front and rear ends. The illustrated horizontally-extending passage 30 is circular-shaped in cross-section but can alternatively have any other suitable shape and/or configuration to cooperate with the upper rim or edge 28 of the brooder 12. To grasp the upper rim or edge 28 of the brooder 12 with the first portion 16, the lower opening or slit 32 of the C-section clamp is placed along the top of the upper rim or edge 28 of the brooder 12 and pushed downward so that the opposed legs of the C-section clamp resiliently defect outwardly and the upper rim or edge 28 of the brooder 12 can pass into the horizontally-extending passage 30 the C-section clamp. The opposed legs then resiliently snap back once the upper rim or edge 28 of the brooder 12 is within the C-section clamp. In this position, the first portion 16 is secured to the upper rim or edge 28 of the brooder 12. It is noted that the interior horizontally-extending passage 30 of the C-section clamp is sized and shaped to closely receive the upper rim or edge 28 of the brooder 12. It is also noted that the first portion 16 of the attachment members 14 can alternatively have any other suitable shape and/or configuration.

As best shown in FIGS. 3 and 4, the illustrated second portion 18 of the attachment member 14 is configured as a vertically-extending tube that is perpendicular to the horizontally extending c-section clamp. The tube forms the vertically-extending passage 20 for receiving one of the end portions 24, 26 of the cross member 22. The vertically-extending passage 16 is open at both the upper and lower ends so that the cross member 22 can extend therethrough and is sized and shaped for closely receiving the cross member 22 with a tight friction fit. The illustrated vertically-extending passage 20 is circular-shaped in cross-section but can alternatively have any other suitable shape and/or configuration to cooperate with the cross member 22. It is noted that the second portion 18 of the attachment members 14 can alternatively have any other suitable shape and/or configuration.

The illustrated attachment members 14 are each produced as a single integral component, that is, as a one piece component as opposed to multiple components secured together. The illustrated attachment members are preferably produced by injection molding but any other suitable manufacturing method can alternatively be utilized. The attachment members can be produced using any suitable injection molding material or thermoplastic such as, for example but not limited to ABS, nylon with CF filler, and the like. It is noted that the attachment members 14 can alternatively have any other suitable shape and/or configuration.

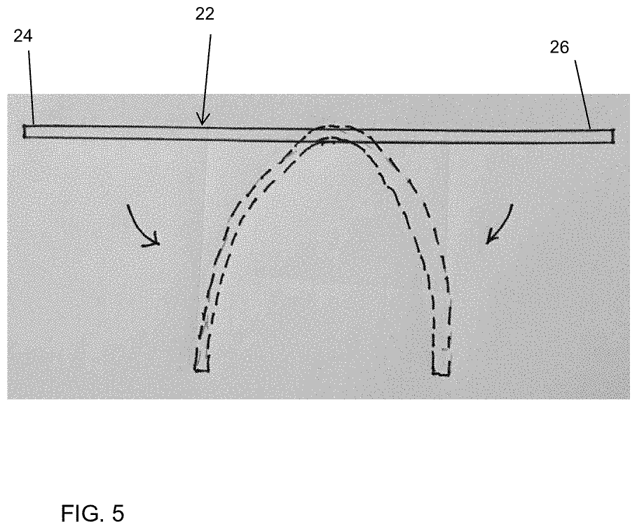

As best shown in FIG. 5, the illustrated cross member 22 is elongate and flexible with first and second opposed ends 24, 26 and an outer surface that is circular-shaped in cross section. The end portions 24, 26 of the cross member 22 are sized and shaped to form a tight friction fit within the vertically-extending passages 20 of the attachment member second portions 18. The illustrated cross member 22 has a suitable flexibility and length such that the cross member 22 can be bent to insert the end portions 24, 26 into the vertically-extending passages 20 of the attachment member second portions 18 to form an arch extending over the brooder 12 for supporting the heat lamp 34 thereon. That is, the cross member 22 is bent such the first and second end portions 24, 26 are substantially parallel. The position of the cross member 22 can be maintained by the friction fit within the vertical passages 20 and/or the laterally outward directed force created by the bent cross member 22. The cross member 22 preferably has an outside diameter of about ½ inch but any other suitable size can alternatively be utilized. The diameter can be smaller or larger depending on the desired flexibility or rigidness of the arch formed by the flexible cross member 22. The illustrated flexible and elongate cross member 22 is a ½ inch diameter schedule 40 PVC pipe. Alternatively, the flexible and elongate cross member 22 can be formed of any other suitable plastic or other material. It is noted that the cross member 22 can alternatively have any other suitable shape and/or configuration.

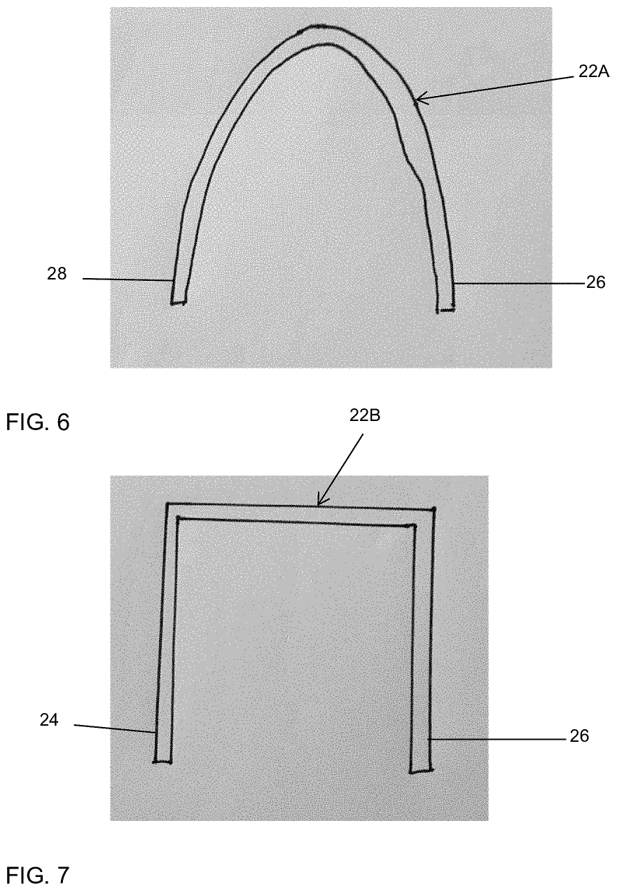

As best shown in FIGS. 6 and 7, the cross member 22 can alternatively be rigid and have a suitable fixed shape. A first illustrated rigid cross member 22A has an inverted U-shape (shown in FIG. 6). A second illustrated rigid cross member 22B has an inverted square U shape (shown in FIG. 7). It is noted that any other suitable fixed shape, having downwardly-extending and substantially parallel end portions 24, 26 sized and shaped to be inserted into the vertically-extending passages 20 of the attachment member second portions 18 can be alternatively utilized. A rigid cross member 22A, 22B is particularly suitable for use with relatively deep stock tanks so that the heat lamp 34 can be lowered below the top rim or edge 28 of the brooder 12 if desired.

The illustrated second portions 18 of the attachment members 14 are provided with a hole or opening 36 (best seen in FIGS. 2 to 4). The opening 36 is sized for selectively inserting a zip screw through the opening 36 to the cross member 22 therein to secure the attachment member 14 to the cross member 22 so as to prevent any possible slipping of the cross member 22 within the vertically-extending passage 20 of the attachment member second portion 18. The opening 36 can alternatively be eliminated if desired and/or any other suitable mechanical means for preventing possible slipping of the cross member 22 within the vertically-extending passage 20 can alternatively be utilized.

The illustrated heat lamp 34 includes an electrically powered infrared bulb 38 or the like and a reflector 40 located above the bulb 38 to downwardly reflect heat. The illustrated heat lamp 34 also includes both a hanger 42 and a clamp 44 so that the heat lamp 34 can be both hung and clamped to the cross member 22 (best seen in FIG. 1) over the brooder 12. It is noted that the heat lamp 34 can alternatively be secured to the cross member 22 in any other suitable manner. The vertical position of the heat lamp 34 can be adjusted by raising or lowering the cross member 22 by pulling the cross member 22 up to slide the cross member 22 further up out of the vertically-extending passages 20 of the attachment member second portions 18 or pushing the cross member 22 down to slide the cross member 22 further down into the vertically-extending passages 20 of the attachment member second portions 18. Thus, the temperature at the bottom of the brooder 12 can be easily adjusted by adjusting the height of the heat lamp 34 over the bottom of the brooder 12.

To heat a brooder 12 using the above described heat lamp support system 10, the second portions 18 the first and second attachment members 14 are secured to the opposed sides of the brooder 12 by snapping the c-clamps onto the top rim or edge 28 of the brooder 12. The first and second end portions 24, 26 of the cross member 22 are inserted into the vertically-extending passages 20 of the second portions 18 of the attachment members 14. If the cross member 22 is a flexible and elongate cross member, the cross member 22 is bent in order to insert the end portions 24, 26 into the attachment member second portions 18 so that the cross member 22 forms an arch over the brooder 12. The radiant heat lamp 34 is secured to the cross member 22 at the top of the cross member 22 between the attachment members 22 using the hanger 42 and/or the clamp 44 so that the radiant heat lamp 34 is positioned over the brooder 12 and directed down toward the brooder 12 to heat the brooder. However, it is noted that the cross member 22 may need to be inserted through the hanger 42 of the radiant heat lamp 34 prior to securing the cross member 22 to at least one of the attachment members 14 depending on the design of the hanger member 42. These steps are preferably performed in the order described above but it is noted that they can alternatively be performed in any other desired order.

It is noted that each of the features of the various disclosed embodiments of the present invention can be utilized in any combination with each of the other disclosed embodiments of the present invention.

From the above disclosure it can be appreciated that the systems, methods and devices according to the present invention can provide reliable, inexpensive, convenient and effective means for securing and/or adjusting the position of a radiant heat lamp over a brooder.

The preferred embodiments of this invention can be achieved by many techniques and methods known to persons who are skilled in this field. To those skilled and knowledgeable in the arts to which the present invention pertains, many widely differing embodiments will be suggested by the foregoing without departing from the intent and scope of the present invention. The descriptions and disclosures herein are intended solely for purposes of illustration and should not be construed as limiting the scope of the present invention.

What is claimed is:

1. A support system for supporting a heat lamp over a brooder having opposed sides, said support system comprising, in combination:
first and second attachment members each having a first portion adapted to be secured to the opposed sides of the brooder and a second portion having a vertically-extending passage; and
a cross member having first and second end portions downwardly extending into the vertically-extending passages of the first and second attachment members so that the cross member extends between the first and second attachment members.

2. The support system according to claim 1, wherein the cross member is flexible and elongate so that the cross member bends to form an arch between the first and second attachment members.

3. The support system according to claim 1, wherein the cross member is rigid.

4. The support system according to claim 1, wherein the cross member is a PVC pipe.

5. The support system according to claim 1, wherein the cross member is slidable within the vertically-extending passages to adjust a height of a top of the cross member between the first and second attachment members.

6. A heat lamp system for a brooder having opposed sides, said heat lamp system comprising, in combination:
first and second attachment members having a first portion adapted to be secured to the opposed sides of the brooder and a second portion having a vertically-extending passage;
a cross member having first and second end portions downwardly extending into the vertically-extending passages of the first and second attachment members so that the cross member extends between the first and second attachment members; and
a heat lamp secured to the cross member between the first and second attachment members.

7. The heat lamp system according to claim 6, wherein the cross member is flexible and elongate so that the cross member bends to form an arch between the first and second attachment members.

8. The heat lamp system according to claim 6, wherein the cross member is rigid.

9. The heat lamp system according to claim 6, wherein the cross member is a PVC pipe.

10. The heat lamp system according to claim 6, wherein the cross member is slidable within each of the vertically-extending passages to adjust a height of a top of the cross member between the first and second attachment members.

11. A brooder system comprising, in combination:
a stock tank having opposed sides;
first and second attachment members each having a first portion secured to one of to the opposed sides of the stock tank and a second portion having a vertically-extending passage;
a cross member having first and second end portions downwardly extending into the vertically-extending passages of the first and second attachment members so that the cross member extends over the stock tank; and
a heat lamp secured to the cross member over the stock tank.

12. The brooder system according to claim 11, wherein the cross member is flexible and elongate so that the cross member bends to form an arch between the first and second attachment members.

13. The brooder system according to claim 11, wherein the cross member is rigid.

14. The brooder system according to claim 11, wherein the cross member is a PVC pipe.

15. The brooder system according to claim 11, wherein the cross member is slidable within the vertically-extending passages to adjust a height of the heat lamp over the stock tank and between the first and second attachment members.

16. A heating method for a brooder having opposed sides, said method comprising the steps of, in combination:
securing first and second attachment members to the opposed sides of the brooder, wherein the first and second attachment members have a first portion adapted to be secured to the opposed sides of the brooder and a second portion having a vertically-extending passage; and
extending first and second end portions of a cross member into the vertically-extending passages of the first and second attachment members so that the cross member extends between the first and second attachment members; and
securing a heat lamp to the cross member between the first and second attachment members and over the brooder.

17. The heating method according to claim 16, wherein the cross member is flexible so that the cross member bends to form an arch between the first and second attachment members.

18. The heating method according to claim 16, wherein the cross member is rigid.

19. The heating method according to claim 16, wherein the cross member is a PVC pipe.

20. The heating method according to claim 16, further comprising the step of sliding the cross member within the vertically-extending passages to adjust a height of the cross member over the brooder and between the first and second attachment members.

21. The heating method according to claim 16, the brooder is a stock tank.
